(19) United States
(12) Patent Application Publication
(10) Pub. No.: US 2026/0079601 A1
(43) Pub. Date: Mar. 19, 2026

(54) SYSTEM AND METHOD FOR MULTI-STEP SCANNING OF TOUCH SENSOR PANEL

(71) Applicant: Apple Inc., Cupertino, CA (US)

(72) Inventors: Tiantong GUO, San Jose, CA (US); Behrooz SHAHSAVARI, Los Altos Hills, CA (US)

(21) Appl. No.: 19/307,989

(22) Filed: Aug. 22, 2025

Related U.S. Application Data
(60) Provisional application No. 63/695,571, filed on Sep. 17, 2024.

(51) Int. Cl. G06F 3/044; G06V 10/70; G06V 10/774

(52) U.S. Cl. CPC G06F 3/044; G06V 10/70; G06V 10/774; G06F 2203/04104

(57) ABSTRACT

The systems and methods disclosed herein are directed to a touch detection system that utilizes a multi-step scanning process to detect touch events occurring on a touch sensor panel. In one or more examples, a touch ASIC transmits a drive signal to a plurality of electrodes on the touch sensor panel. In a first step of the multi-step process, a first set of sense electrodes are scanned to generate a first partial touch image. In one or more examples, and in a second step of the multi-step process, a second set of sense electrodes are scanned to generate a second partial touch image. In one or more examples, the first partial touch image and the second partial touch image are inputted into a machine learning model to generate an integrated touch image.

### CROSS REFERENCE TO RELATED APPLICATION

This application claims the benefit of U.S. Provisional Application No. 63/695,571, filed Sep. 17, 2024, the entire disclosure of which is herein incorporated by reference for all purposes.

### FIELD OF THE DISCLOSURE

This relates generally to the operation of capacitive touch sensor panels for use in electronic devices to detect touch signals.

### BACKGROUND OF THE DISCLOSURE

Many types of input devices are presently available for performing operations in a computing system, such as buttons or keys, mice, trackballs, joysticks, touch sensor panels, touch screens and the like. Touch screens, in particular are popular because of their case and versatility of operation as well as their declining price. Touch screens can include a touch sensor panel, which can be a clear panel with a touch-sensitive surface, and a display device such as a liquid crystal display (LCD), light emitting diode (LED) display or organic light emitting diode (OLED) display that can be positioned partially or fully behind the panel so that the touch-sensitive surface can cover at least a portion of the viewable area of the display device. Touch screens can allow a user to perform various functions by touching the touch sensor panel using a finger, stylus or other object at a location often dictated by a user interface (UI) being displayed by the display device. In general, touch screens can recognize a touch and the position of the touch on the touch sensor panel, and the computing system can then interpret the touch in accordance with the display appearing at the time of the touch, and thereafter can perform one or more actions based on the touch. In the case of some touch sensing systems, a physical touch on the display is not needed to detect a touch. For example, in some capacitive-type touch sensing systems, fringing electrical fields used to detect touch can extend beyond the surface of the display, and objects approaching near the surface may be detected near the surface without actually touching the surface. In some examples, a touch screen or touch sensor panel can detect touches by or proximity of multiple objects (e.g., one or more fingers or other touch objects), and such interactions can be used to perform various inputs using multiple objects. Such a touch screen or touch sensor panel may be referred to as a “multi-touch” touch screen or touch sensor panel, and may accept “multi-touch gestures” as inputs.

Capacitive touch sensor panels can be formed by a matrix of transparent, semi-transparent or non-transparent conductive plates made of materials such as Indium Tin Oxide (ITO). In some examples, the conductive plates can be formed from other materials including conductive polymers, metal mesh, graphene, nanowires (e.g., silver nanowires) or nanotubes (e.g., carbon nanotubes). In some implementations, due in part to their substantial transparency, some capacitive touch sensor panels can be overlaid on a display to form a touch screen, as described above. Some touch screens can be formed by at least partially integrating touch sensing circuitry into a display pixel stack-up (i.e., the stacked material layers forming the display pixels).

### SUMMARY OF THE DISCLOSURE

The systems and methods disclosed herein are directed to a touch detection system that utilizes a multi-step scanning process to detect touch events occurring on a touch sensor panel. In one or more examples, a touch ASIC (or other processor) transmits a drive signal to a plurality of electrodes on the touch sensor panel. In a first step of the multi-step process, a first set of sense electrodes are scanned to generate a first partial touch image. In one or more examples, and in a second step of the multi-step process, a second set of sense electrodes are scanned to generate a second partial touch image. In some examples, the first set of sense electrodes and the second set of sense electrodes include one or more common electrodes (e.g., sense electrodes that are common to both the first set and the second) and further include mutually exclusive sense electrodes (e.g., sense electrodes that are either part of the first set or the second set but not both).

In one or more examples, the first set of sense electrodes form a repeating pattern across a touch sensor panel wherein a first sub-group of the first set of scanned electrodes are followed by a first group of non-scanned sense electrodes, followed by a second sub-group of the first set of scanned electrodes, followed by a second group of non-scanned sense electrodes, and so and so forth over the entirety of the touch sensor panel. In some examples, instead of performing a multi-step scan of the sense electrodes as described above, the system performs a multi-step drive process for the drive electrodes of the touch sensor panel and generates partial touch images.

In one or more examples, a machine learning model is applied to the first partial touch image and the second partial touch image to generate an integrated touch image that is used to determine the location of a touch input on the touch sensor panel. In some examples, the machine learning model is configured to discriminate touch signals from noise signals found in the partial touch images when generating the integrated touch image. In one or more examples, the first partial touch image and the second partial touch image are concatenated prior to being inputted into the machine learning model. Additionally and/or alternatively, the first partial touch image and the second partial touch image are combined into a single touch image prior to being inputted into the machine learning model. In some examples, combining includes averaging the first partial touch image with the second partial touch image.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates a multi-touch sensing device used as an input device to a computer system in accordance with one or more examples of the disclosure.

FIG. 2 illustrates a plurality of contact patch areas corresponding to an object in proximity to a plurality of sense points of a multi-touch surface in accordance with one or more examples of the disclosure.

FIG. 3 illustrates a simplified schematic diagram of a mutual capacitance sensing circuitry that may be used in one or more examples of the disclosure.

FIG. 4 illustrates an exemplary touch sensor panel system according to examples of the disclosure.

FIG. 5 illustrates an exemplary touch sensor panel system in which the number of receive pins of the touch ASIC are less than the number of sense electrodes of the touch sensor panel, according to one or more examples of the disclosure.

FIG. 6 illustrates an exemplary multi-step scanning process for a touch sensor panel according to one or more examples of the disclosure.

FIG. 7 illustrates a method of integrating touch images produced by a multi-step touch scanning process according to examples of the disclosure.

FIG. 8 illustrates another exemplary method of integrating touch images produced by a multi-step touch scanning process according to examples of the disclosure.

FIG. 9 illustrates an exemplary multi-step touch detection process according to one or more examples of the disclosure.

FIG. 10 illustrates an exemplary process flow for a multi-step touch detection process according to one or more examples of the disclosure.

FIG. 11 illustrates another exemplary process flow for a multi-step touch detection process according to one or more examples of the disclosure.

FIG. 12 illustrates a computing system including a touch screen according to examples of the disclosure.

### DETAILED DESCRIPTION

The systems and methods disclosed herein are directed to a touch detection system that utilizes a multi-step scanning process to detect touch events occurring on a touch sensor panel. In one or more examples, a touch ASIC (or other processor) transmits a drive signal to a plurality of electrodes on the touch sensor panel. In a first step of the multi-step process, a first set of sense electrodes are scanned to generate a first partial touch image. In one or more examples, and in a second step of the multi-step process, a second set of sense electrodes are scanned to generate a second partial touch image. In some example, the first set of sense electrodes and the second set of sense electrodes include one or more common electrodes (e.g., sense electrodes that are common to both the first set and the second) and further include mutually exclusive sense electrodes (e.g., sense electrodes that are either part of the first set or the second set but not both).

In one or more examples, the first set of sense electrodes form a repeating pattern across a touch sensor panel wherein a first sub-group of the first set of scanned electrodes are followed by a first group of non-scanned sense electrodes, followed by a second sub-group of the first set of scanned electrodes, followed by a second group of non-scanned sense electrodes, and so and so forth over the entirety of the touch sensor panel. In some examples, instead of performing a multi-step scan of the sense electrodes as described above, the system performs a multi-step drive process for the drive electrodes of the touch sensor panel and generates partial touch images.

In one or more examples, a machine learning model is applied to the first partial touch image and the second partial touch image to generate an integrated touch image that is used to determine the location of a touch input on the touch sensor panel. In some examples, the machine learning model is configured to discriminate touch signals from noise signals found in the partial touch images when generating the integrated touch image. In one or more examples, the first partial touch image and the second partial touch image are concatenated prior to being inputted into the machine learning model. Additionally and/or alternatively, the first partial touch image and the second partial touch image are combined into a single touch image prior to being inputted into the machine learning model. In some examples, combining includes averaging the first partial touch image with the second partial touch image.

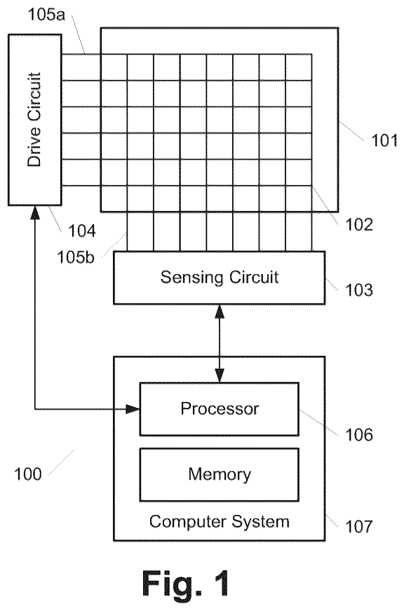

Recognizing multiple simultaneous or near-simultaneous touch events may be accomplished with a multi-touch sensing arrangement as illustrated in FIG. 1. Multi-touch sensing arrangement 100 can detect and monitor multiple touch attributes (including, for example, identification, position, velocity, size, shape, and magnitude) across touch sensitive surface 101, at the same time, nearly the same time, at different times, or over a period of time. Touch sensitive surface 101 can provide a plurality of sensor points, coordinates, or nodes 102 that function substantially independently of one another and that represent different points on a touch sensitive surface. Sensing points 102 may be positioned in a grid or array, with each sensing point capable of generating a signal at the same time. Sensing points 102 may be considered as mapping touch sensitive surface 101 into a coordinate system, for example, a Cartesian or polar coordinate system.

A touch sensitive surface may, for example, be in the form of a tablet or a touch screen. To produce a touch screen, the capacitance sensing points and other associated electrical structures can be formed with a substantially transparent conductive medium, such as indium tin oxide (ITO). The number and configuration of sensing points 102 may be varied. The number of sensing points 102 generally depends on the desired resolution and sensitivity. In touch-screen applications, the number of sensing points 102 may also depend on the desired transparency of the touch screen.

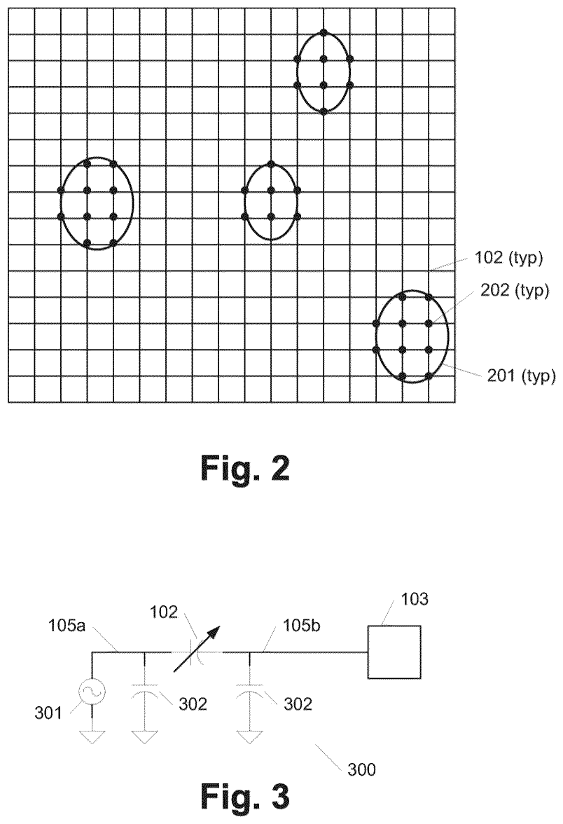

Using a multi-touch sensing arrangement, like that described in greater detail below, signals generated at nodes 102 of multi-touch sensor 101 may be used to produce an image of the touches at a particular point in time. For example, each object (e.g., finger, stylus, etc.) in contact with or in proximity to touch sensitive surface 101 can produce contact patch area 201, as illustrated in FIG. 2. Each of contact patch area 201 may cover several nodes 102. Covered nodes 202 may detect the object, while remaining nodes 102 do not. As a result, a pixilated image of the touch surface plane (which may be referred to as a touch image, a multi-touch image, or a proximity image) can be formed. The signals for each contact patch area 201 may be grouped together. Each contact patch area 201 may include high and low points based on the amount of touch at each point. The shape of contact patch area 201, as well as the high and low points within the image, may be used to differentiate contact patch areas 201 that are in close proximity to one another. Furthermore, the current image can be compared to previous images to determine how the objects may be moving over time, and what corresponding action should be performed in a host device as a result thereof.

Many different sensing technologies can be used in conjunction with these sensing arrangements, including resistive, capacitive, optical, etc. In capacitance-based sensing arrangements, as an object approaches touch-sensitive surface 101, a small capacitance forms between the object and sensing points 102 in proximity to the object. By detecting changes in capacitance at each of the sensing points 102 caused by this small capacitance, and by noting the position of the sensing points, a sensing circuit 103 (also referred to as sensing circuitry) can detect and monitor multiple touches. The capacitive sensing nodes may be based on self-capacitance or mutual capacitance.

In self capacitance systems, the “self” capacitance of a sensing point is measured relative to some reference, e.g., ground. Sensing points 102 may be spatially separated electrodes. These electrodes are coupled to driving circuitry 104 and sensing circuitry 103 by conductive traces 105a (drive lines) and 105b (sense lines). In some self-capacitance examples, a single conductive trace to each electrode may be used as both a drive and sense line.

In mutual capacitance systems, the “mutual” capacitance between a first electrode and a second electrode can be measured. In mutual capacitance sensing arrangements, the sensing points may be formed by the crossings of patterned conductors forming spatially separated lines. For example, drive lines 105a may be formed on a first layer and sense lines 105b may be formed on a second layer such that the drive and sense lines cross or “intersect” one another at sensing points 102. The different layers may be different substrates, different sides of the same substrate, or the same side of a substrate with some dielectric separation. Because the drive and sense lines are separated, there is a capacitive coupling node at each “intersection.”

The manner in which the drive and sense lines are arranged may vary. For example, in a Cartesian coordinate system (as illustrated), the drive lines may be formed as horizontal rows, while the sense lines may be formed as vertical columns (or vice versa), thus forming a plurality of nodes that may be considered as having distinct x and y coordinates. Alternatively, in a polar coordinate system, the sense lines may be a plurality of concentric circles with the drive lines being radially extending lines (or vice versa), thus forming a plurality of nodes that may be considered as having distinct r and angle coordinates. In either case, drive lines 105a may be connected to driving circuitry 104, and sense lines 105b may be connected to sensing circuitry 103.

During operation, a drive signal (e.g., a periodic voltage) is applied to each drive line 105a. When driven, the charge impressed on drive line 105a can capacitively couple to the intersecting sense lines 105b through nodes 102. This can cause a detectable, measurable current and/or voltage in sense lines 105b. The relationship between the drive signal and the signal appearing on sense lines 105b is a function of the capacitance coupling the drive and sense lines, which, as noted above, may be affected by an object in proximity to node 102. Capacitance sensing circuitry (e.g., one or more sensing circuits) 103 may sense sense lines 105b and may determine the capacitance at each node as described in greater detail below.

As discussed above, some single-stimulation signals drive drive lines 105a one at a time, while the other drive lines were grounded. This process was repeated for each drive line 105a until all the drive lines had been driven, and a touch image (based on capacitance) was built from the sensed results. Once all the drive lines 105a had been driven, the sequence would repeat to build a series of touch images. However, in some examples of the present disclosure, multiple drive lines may be driven simultaneously or nearly simultaneously, as described, for example, below. As used herein, “simultaneously” encompasses precisely simultaneous as well as nearly simultaneous events. For example, simultaneous events may begin at about the same time, end at about the same time, and/or take place over at least partially overlapping time periods.

FIG. 3 illustrates a simplified schematic diagram of mutual capacitance circuit 300 corresponding to the arrangement described above. Mutual capacitance circuit 300 may include drive line 105a and sense line 105b, which are spatially separated thereby forming capacitive coupling at nodes 102. Drive line 105a may be electrically (i.e., conductively) coupled to driving circuitry 104 represented by voltage source 301. Sense line 105b may be electrically coupled to capacitive sensing circuitry 103. Both drive line 105a and sense line 105b may, in some cases, include some parasitic capacitance 302.

As noted above, in the absence of a conductive object proximate the intersection of drive line 105a and sense line 105b, the capacitive coupling at node 102 stays fairly constant. However, if an electrically conductive object (for example, a user's finger, stylus, etc.) comes in proximity to node 102, the capacitive coupling (i.e., the capacitance of the local system) changes. The change in capacitive coupling changes the current (and/or voltage) carried by sense line 105b. Capacitance sensing circuitry 103 may note the capacitance change and the position of node 102 and report this information in some form to processor 106 (FIG. 1).

With reference to FIG. 1, sensing circuitry 103 may acquire data from touch surface 101 and supply the acquired data to processor 106. In some examples, sensing circuitry 103 may be configured to send raw data (e.g., an array of capacitance values corresponding to each sense point 102) to processor 106. In other examples, sensing circuitry 103 may be configured to process the raw data itself and deliver processed touch data to processor 106. In either case, the processor may then use the data it receives to control operation of computer system 107 and/or one or more applications running thereon. Various implementations along these lines are described in the applications referenced above, and include a variety of computer systems having touch pads and touch screens.

In some examples, sensing circuitry 103 may include one or more microcontrollers, each of which may monitor one or more sensing points 102. The microcontrollers may be application specific integrated circuits (ASICs), that work with firmware to monitor the signals from touch sensitive surface 101, process the monitored signals, and report this information to processor 106. The microcontrollers may also be digital signal processors (DSPs). In some examples, sensing circuitry 103 may include one or more sensor ICs that measure the capacitance in each sense line 105b and report measured values to processor 106 or to a host controller (not shown) in computer system 107. Any number of sensor ICs may be used. For example, a sensor IC may be used for all lines, or multiple sensor ICs may be used for a single line or group of lines.

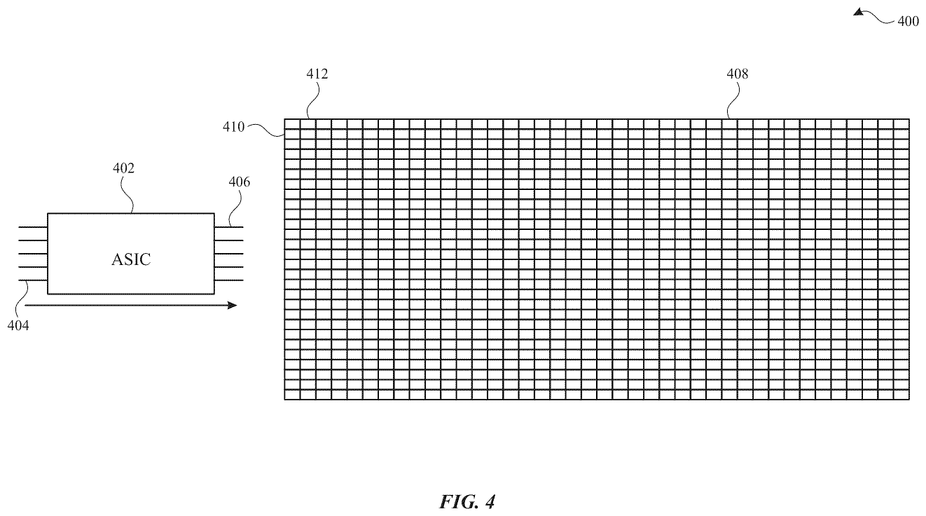

FIGS. 4-8 illustrate exemplary methods and systems for implementing a multi-step touch sensor scanning process according to examples of the disclosure. FIG. 4 illustrates an exemplary touch sensor panel system according to example of the disclosure. In one or more examples, the exemplary touch sensor panel system 400 illustrated in FIG. 4 includes a touch sensor panel 408 which includes a matrix of drive electrodes 410 and sense electrodes 412 that are disposed within the touch sensor panel, similar to the examples described above with respect to FIGS. 1-3. Thus, in some examples, the drive electrodes 410 are driven with a drive signal, and are capacitively coupled to the sense electrodes 412. The sense electrodes 412 are then connected to sense circuitry that are configured to determine if a touch signal (e.g., a user touch) is present at a particular junction of the drive electrode with the sense electrode (e.g., as described above with respect to FIGS. 1-3).

In one or more examples, the drive electrodes 410 and the sense electrodes 412 are communicatively coupled to a touch application-specific integrated circuit (ASIC) 402. In one or more examples, touch ASIC 402 is configured to perform at least two separate functions: (1) transmit drive signals to each of the drive electrodes 410, and (2) receive/scan touch signals from each of the sense electrodes 412 (e.g., scan the sense electrodes) and process the received touch signals to determine the location of one or more touch signals on the touch sensor panel 408. In one or more examples, touch ASIC 402 includes a plurality of transmit pins 406, wherein each transmit pin 406 is communicatively coupled to the one or more drive electrodes 410 and is configured to transmit a drive signal to the one more drive electrodes 410. In one or more examples, touch ASIC 402 includes a plurality of receive pins 404, wherein each receive pin 404 is communicatively coupled to the one or more sense electrodes 412, and is configured to scan touch signals from each of the sense electrodes 412 to the touch ASIC 402 for further processing (e.g., to determine the presence or absence of touch signals on the touch sensor panel 408).

In the example of FIG. 4, the number of transmit pins 406 and the number of receive pins 404 is equal to the number of drive electrodes 410 and the number of sense electrodes 412, respectively. For instance in the example of FIG. 4, and as a non-limiting example, touch sensor panel 408 includes 28 separate drive electrodes 410 and 40 separate sense electrodes 412, and thus touch ASIC 402 includes 28 separate transmit pins 406 and 40 separate receive pins 404 (e.g., the number of transmit pins and receive pins equals the number of drive electrodes and sense electrodes respectively).

In one or more examples, by having a transmit pin 406 for every drive electrode 410, and a receive pin 404 for every sense electrode 412 of the touch sensor panel 408, the touch ASIC 402 is able to scan the entirety of the touch sensor panel 408 in a single step, wherein each drive electrodes is stimulated simultaneously (e.g., driven with a drive signal) and each sense electrode is scanned by the touch ASIC 402 simultaneously to detect the location of one or more touch signals on the touch sensor panel. Thus, the example of FIG. 4 may require a touch ASIC 402 that includes enough transmit and receive pins to match the size of the touch sensor panels (e.g., the number of drive electrodes and sense electrodes). In some examples, the size of the touch ASIC 402 (e.g., the physical footprint of the touch ASIC) is based on the number of transmit and receive pins, and thus if the size of the touch sensor panel were to be increased (e.g., more drive and/or sense electrodes are added to the touch sensor panel), the physical size of the touch ASIC would also be required to be increased to account for the extra transmit pins and receive pins required to scan the touch sensor panel in a single. Often times, the requirement can constrain the size of the touch sensor panel because increasing the size of the touch ASIC is not possible (e.g., because there may not be enough physical space in the electronic device to accommodate a larger touch ASIC). Similarly, the overall size of the electronic device may not be made smaller due to the need to accommodate a touch ASIC that is large enough to scan the touch sensor panel.

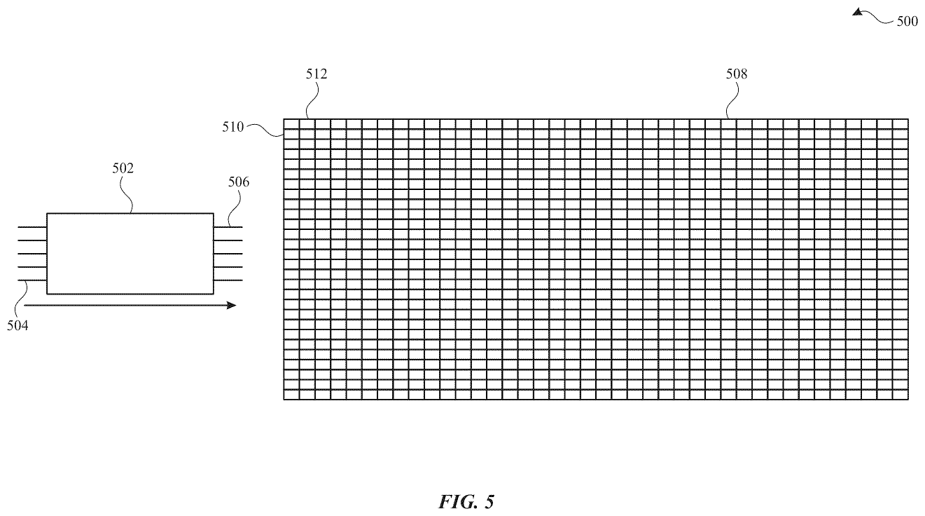

FIG. 5 illustrates an exemplary touch sensor panel system in which the number of receive pins of the touch ASIC are less than the number of sense electrodes of the touch sensor panel, according to one or more examples of the disclosure. In the example of FIG. 5, touch sensor panel system 500, includes a touch sensor panel 508 that is substantially similar to the touch sensor panel 408 described with respect to FIG. 4 including having the same number of drive electrodes 510 and the same number of sense electrodes 512 as the touch sensor panel 408 of FIG. 4. Similarly, touch sensor panel system 508 also includes a touch ASIC 502 that operates in substantially the same manner as described with respect to touch ASIC 402 of FIG. 4.

In one or more examples, touch ASIC 502 includes the same number of transmit pins 506 as the number of transmit pins 406 that are part of touch ASIC 402 in the example of FIG. 4. For instance, as illustrated in FIG. 5, touch ASIC 502 includes 40 transmit pins 506 similar to the example of touch ASIC 402 which included 40 transmit pins 406. However, in contrast to the example of FIG. 4, touch ASIC 502 includes a smaller number of receive pins 504 (e.g., 33) in contrast to the 40 receive pins 404 of touch ASIC 402. In some examples, due to the reduction in the number of receive pins, touch ASIC 502 may be physically smaller than touch ASIC 402 thus allowing for the electronic device that houses touch ASIC 402 to also be smaller.

Thus, in the example of FIG. 5, because touch ASIC 502 has fewer receive pins 404, the touch ASIC 502 may be substantially smaller in physical size (e.g., the footprint) than the touch ASIC 402 in the example of FIG. 4. However, in the example of FIG. 5 the number of receive pins 504 is less than the number of sense electrodes 512, thus meaning that the touch sensor panel 508 cannot be scanned in a single scan because not all of the sense electrodes 512 can be scanned simultaneously. In a system that requires simultaneous scanning of all sense electrodes 512, a touch ASIC, such as touch ASIC 502 that is smaller (due to less receive pins) would not be possible. However, as described in detail below, employing a multi-step scanning process can allow for a reduced touch ASIC footprint and/or an increased touch sensor panel size (without requiring a subsequent increase in the size of the touch ASIC).

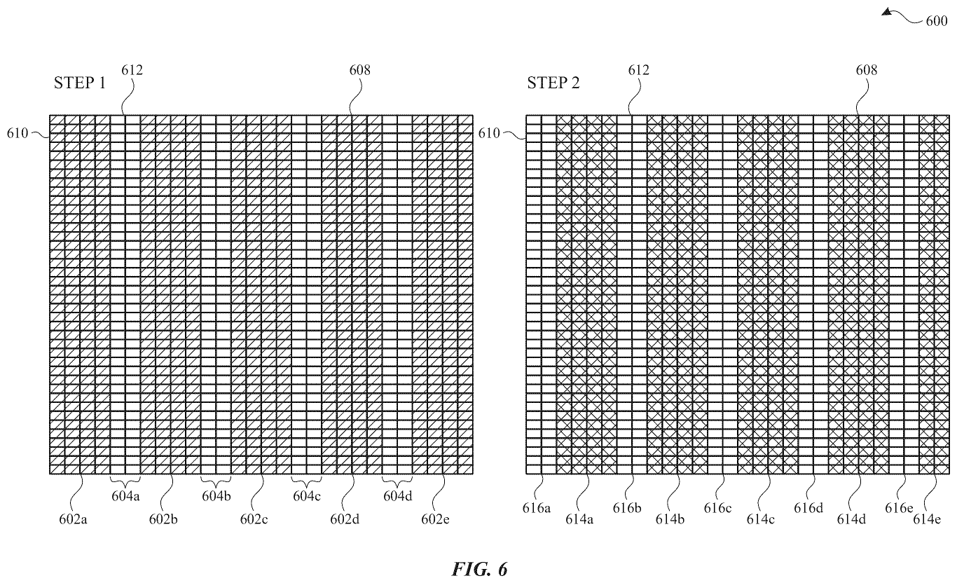

FIG. 6 illustrates an exemplary multi-step scanning process for a touch sensor panel according to examples of the disclosure. In the example 600 of FIG. 6, the scanning process for a touch sensor panel (e.g., scanning each and every sense electrode at least once to form a complete touch image) is divided into two steps, which are labeled in the figure as “Step 1” and “Step 2.” In contrast, the examples described above with respect to FIG. 4, only had a single step because all of the sense electrodes could be scanned simultaneously. In the example 600 of FIG. 6, a first group of sense electrodes are scanned in a first step 1, while a second group (which included some sense electrodes that were part of the first group) are driven at a second step (described in further detail below). In one or more examples, the first group and the second group collectively include each and every sense electrode of the touch sensor panel such that at the conclusion of the second step of the multi-step scanning process, all of the sense electrodes of the touch sensor panel have been scanned.

In one or more examples, the first step of the multi-step scanning process (referred to in FIG. 6 as Step 1) includes scanning a first group of sense electrodes 612. In one or more examples, the first group of sense electrodes includes a plurality of sub-groups of sense electrodes 602a-602e. Optionally, each sub-group of sense electrodes 602a-602e includes one or more adjacent sets of sense electrodes (e.g., sense electrodes that are next to one another and/or have no non-scanned electrodes intervening between them). In some examples, each sub-group of sense electrodes 602a-602e are separated from one another by one or more groups of non-scanned sense electrodes 604a-604d. In one or more examples, the non-scanned sense electrodes 604a-604d of Step 1 represent the sense electrodes 612 that are not scanned during Step 1 (even though the sense electrodes themselves may receive a touch signal due to the drive electrodes 610 being driven during step 1). In one or more examples, at step 1, the touch ASIC receives a partial touch image that includes any touch inputs applied to the portions of the touch sensor panel that coincide with the intersections of the drive electrodes 610 with the sense electrodes belonging to sub-groups 602a-602e (e.g., the sense electrodes 612 of touch sensor panel 608 that are scanned as part of Step 1).

In one or more examples, upon completion of Step 1, the process of example 600 moves to Step 2 wherein a second touch image is generated by driving all of the drive electrodes 610 of touch sensor panel 608 and scanning a second sub-group 614a-614e of sense electrodes 612. In some examples, the second sub-group 614a-614e of sense electrodes includes the sense electrodes that were not previously scanned as part of Step 1. Optionally, and as illustrated in the example 600 of FIG. 6, the second sub-group 614a-614e include one or more sense electrodes 612 that were also previously scanned as part of Step 1 of the multi-step scanning process. In some examples, each sub-group of sense electrodes 614a-614e are separated from one another by one or more groups of non-scanned sense electrodes 616a-616e. In one or more examples, the non-scanned sense electrodes 616a-616e of Step 2 represent the sense electrodes 612 that are not scanned during Step 2 (even though the sense electrodes themselves may receive a touch signal due to the drive electrodes 610 being driven during Step 2). In one or more examples, at Step 2, the touch ASIC receives a partial touch image that includes any touch inputs applied to the portions of the touch sensor panel that coincide with the intersections of the drive electrodes 610 with the sense electrodes belonging to sub-groups 614a-614e (e.g., the sense electrodes 612 of touch sensor panel 608 that are scanned as part of Step 2).

In one or more examples, the first sub-group 602a-602e of sense electrodes scanned as part of Step 1, and the second sub-group 614a-614e scanned as part of Step 2 form distinct patterns across the touch sensor panel. For instance, as illustrated in example 600 of FIG. 6, at the left edge of the touch sensor panel, in Step 1, the first four sense electrodes (e.g., sub-group 602a) are scanned as part of Step 1. In some examples, first sub-group 602a is separated from second sub-group 602b by the first sub-group of non-scanned sense electrodes 604a. As illustrated in the example of Step 1, the first four sense electrodes of touch sensor panel 608 are scanned, then the next two sense electrodes are non-scanned, and the pattern repeats for the entirety of the touch sensor panel 608.

In one or more examples, the pattern of sense electrodes sub-groups is different in Step 2 with respect to Step 1. For instance, as shown in Step 2, the pattern begins (from the left side to touch sensor panel 608) with a first group of non-scanned electrodes 616a, followed by the first sub-group 614a of sense electrodes that are scanned as part of step 2. This pattern optionally repeats (e.g., 2 non-scanned, followed by two scanned sense electrodes) from left to right for the entirety of the touch sensor panel 608. In some examples, the starting sense electrode of the second sub-group of sense electrodes is displaced from the left edge of the touch sensor by the number of non-scanned sense electrodes that separate the first sub-group 602a and the second sub-group 602b of the first set of sense electrodes. For instance, as illustrated in the example of FIG. 6, the first sub-group 602a includes four sense electrodes 612, the second sub-group 602b includes four sense electrodes 614, and sub-groups 602a and 602b are separated by two non-scanned sense electrodes 604a. In some examples, because there are two non-scanned sense electrodes between sub-groups of scanned electrodes, the second set of sense electrodes (e.g., the sense electrodes scanned during the second step of the multi-step scanning process) will not begin until the third sense electrode from the left edge of the touch sensor panel 708, with the first two sense electrodes (e.g., sub-group 616a of the touch sensor panel (e.g., from the left edge) being non-scanned as part of the second step of the multi-step scanning process.

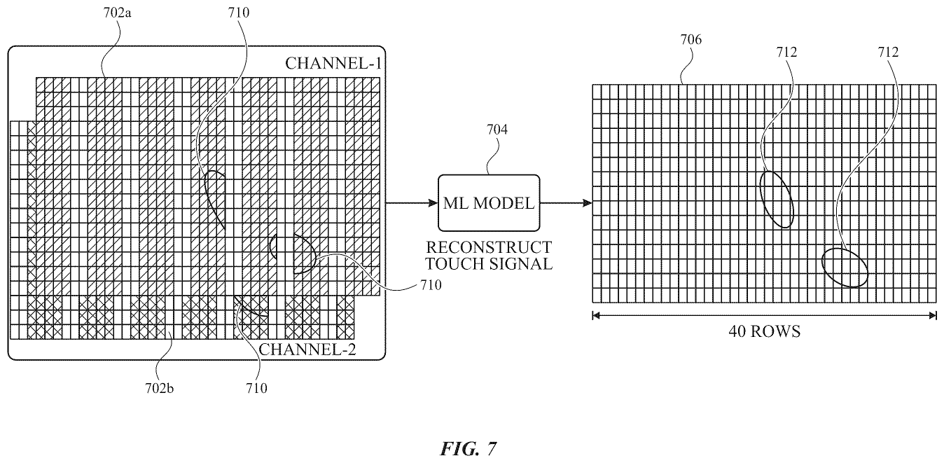

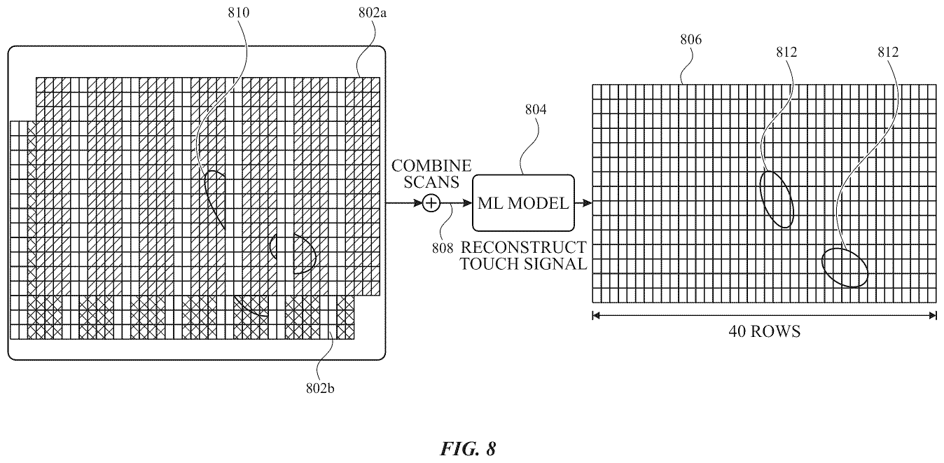

In one or more examples, the touch ASIC generates a touch image for each step of the multi-step process (described in further detail below), and the electronic device 201 (e.g., a process associated with the electronic device) utilizes the two touch images to generate a final output touch image that integrates the first touch image (associated with the first step of the multi-step process) and the second touch image (associated with the second step of the multi-step process) as illustrated in the examples of FIG. 7-8. FIG. 7 illustrates a method of integrating touch images produced by a multi-step touch scanning process according to examples of the disclosure. In the example 700 of FIG. 7, two partial touch images 702a and 702b have been produced as part of the multi-step scanning process described above with respect to FIG. 6. The partial touch images can include one or more partial touch signals (e.g., partial because the partial touch images 702a and 702b do not represent complete scans of the touch sensor panel and thus the partial touch images may include only partial touch signals).

In one or more examples, the two partial touch images 702a and 702b are input into a machine learning model 704 that acts to integrate the partial touch images 702a and 702b into an integrated output image 706 that represents a complete scan of the touch sensor panel of electronic device 101. In some examples, the machine learning model (e.g., a neural network that includes one or more layers implemented in either hardware, software, or both) generates an integrated output touch image 706 that includes complete touch signals 712. In some examples, machine learning model 704 includes any type of machine learning classifier including but not limited a supervised learning model, a semi-supervised learning model, and an unsupervised learning model. In one or more examples, a machine learning classifier for the purposes of the present disclosure can refer to a machine learning regression model. In some examples, the machine learning model is used to not only produce an integrated touch image from the first and second touch images, but also to discriminate (e.g., classify) touch signals in the first and second image from noise signals. In one or more examples, the output of the machine learning model 704 (e.g., the integrated output touch image 706) includes an indication of the location on the touch sensor panel where a touch input has been detected with any noise signals (signals caused by internal or external noise to the electronic device) either removed completely or substantially reduced to thereby produce a high-fidelity (e.g., the probability of a false touch reduced to below a threshold amount) touch image that can be used by the electronic device for the purpose of determining the location of a touch signal.

In one or more examples, and as illustrated in the example 700 of FIG. 7, partial touch images 702a and 702b are concatenated prior to having the machine learning model 704 applied to them. As illustrated in example 700, the first partial touch image 702a and the second partial touch image 702b (e.g., the product of the first step and second step, respectively) are concatenated either prior to being input into the machine learning model, or by the machine learning model itself. In some examples, concatenating the first partial touch image 702a and the second partial touch image 702b includes inputting the first partial touch image and the second touch partial image as a single larger image (e.g., the first touch image and the second touch image are serially combined) to form a large touch image that the machine learning model is trained to operate on (e.g., the machine learning model 704 is trained to input a concatenated touch image and output an integrated touch image). In some examples, machine learning model 702 receives the partial touch images 702a and 702b already concatenated (e.g., combined serially). Additionally and or alternatively, machine learning model 704 is configured to concatenate the partial touch images 702a and 702b as part of the process of applying the machine learning model to generate an output touch image.

In one or more examples, rather than concatenating the two partial touch images (as in the example 700 of FIG. 7), the partial touch signals generated at each step of the multi-step scanning process can be combined into a single touch image. FIG. 8 illustrates another exemplary method of integrating touch images produced by a multi-step touch scanning process according to examples of the disclosure. In the example 800 of FIG. 8, two partial touch images 802a and 802b have been produced as part of the multi-step scanning process described above with respect to FIG. 6. The partial touch images can include one or more partial touch signals 810 (e.g., partial because the partial touch images 702a and 702b do not represent complete scans of the touch sensor panel and thus the partial touch images may include only partial touch signals).

In one or more examples, the two partial touch images 802a and 802b are input into a machine learning model 804 that acts to integrate the partial touch images 802a and 802b into an integrated output image 806 that represents a complete scan of the touch sensor panel of electronic device 101. In some examples, the machine learning model (e.g., a neural network that includes one or more layers implemented in either hardware, software, or both) generates an integrated output touch image 806 that includes complete touch signals 812 (similar to the example of FIG. 7). In some examples, machine learning model 804 includes any type of machine learning classifier including but not limited a supervised learning model, a semi-supervised learning model, and an unsupervised learning model. In some examples, the machine learning model is used to not only produce an integrated touch image from the first and second touch images, but also to discriminate (e.g., classify) touch signals in the first and second image from noise signals. In one or more examples, the output of the machine learning model 804 (e.g., the integrated output touch image 806) includes an indication of the location on the touch sensor panel where a touch input has been detected with any noise signals (signals caused by internal or external noise to the electronic device) either removed completely or substantially reduced to thereby produce a high-fidelity (e.g., the probability of a false touch reduced to below a threshold amount) touch image that can be used by the electronic device for the purpose of determining the location of a touch signal.

In one or more examples, and as illustrated in the example 800 of FIG. 8, partial touch images 802a and 802b are combined prior to having the machine learning model 804 applied to them. As illustrated in example 800, the first partial touch image 802a and the second partial touch image 802b (e.g., the product of the first step and second step, respectively) are combined either prior to being input into the machine learning model 804, or by the machine learning model itself. In some examples, combining the first partial touch image 802a and the second partial touch image 802b includes inputting the first touch image and the second touch image as a single image (e.g., the first touch image and the second touch image are combined to form a single touch image that is then inputted into the machine learning model 804) to form a single output touch image that the machine learning model is trained to operate on (e.g., the machine learning model is trained to input a combined touch image and output an integrated touch image). In some examples, combining the first partial touch image 802a with the second partial touch image 802b includes generating a single touch image based on the first touch image and the second touch image to create an integrated touch image that is then inputted into a machine learning model. In the example of combining, the input to the machine learning model is a single touch image that is generated out of the first partial touch image 802a and the second partial touch image 802b. In contrast, in the example of concatenation of example 700, the first partial touch image and the second partial touch image are separate inputs into the machine learning model that acts on the individual image to create an integrated output touch image (as described above).

In some examples, combining the first partial touch image 802a and the second partial touch image 802b includes averaging the first partial touch image with the second partial touch image. In some examples, the common sense electrodes (e.g., the sense electrodes that are both in the first set of sense electrodes (described above) and the second set of sense electrodes are averaged as part of the process to combine the first partial touch image 802a and the second partial touch image 802b. In some examples, the non-common sense electrodes (e.g., the sense electrodes that are either part of the first set of sense electrodes or the second set of sense electrodes, but not both) are added to the integrator without averaging because there is only one scan of the non-common sense electrode in the multi-step scanning process. In one or more examples, the first partial touch image 802a and the second partial touch image 802b can be equally weighted when averaging is performed. Alternatively, in some examples, the first partial touch image and the second partial touch image can be weighted (e.g., one touch image is weighted higher than the other) when averaging.

In one or more examples, the multi-step scanning process described above with respect to scanning a first set of sense electrodes in a first step and a second set of sense electrodes at a second step, can also be applied to the drive electrodes of a touch sensor panel. Thus, in one or more examples, in a first step of the scanning process, a first set of drive electrodes are driven (e.g., the transmit pins of the touch ASIC are connected to the first set of drive electrodes and transmit a drive signal to the drive electrodes of the first set of drive electrodes). In the second step of the scanning process, a second set of drive electrodes (described in further detail below) are driven (e.g., the transmit pins of the touch ASIC are connected to the second set of drive electrodes and transmit a drive signal to the drive electrodes of the first set of drive electrodes). The sense electrodes are all scanned during both the first and second steps of a multi-step scanning process that switches between driving the first set of drive electrodes and the second set of drive electrodes.

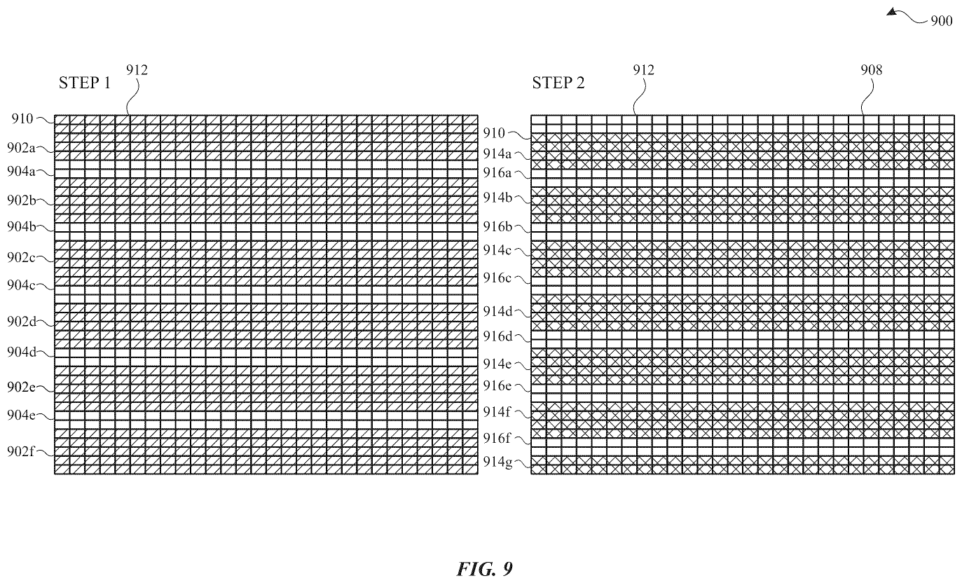

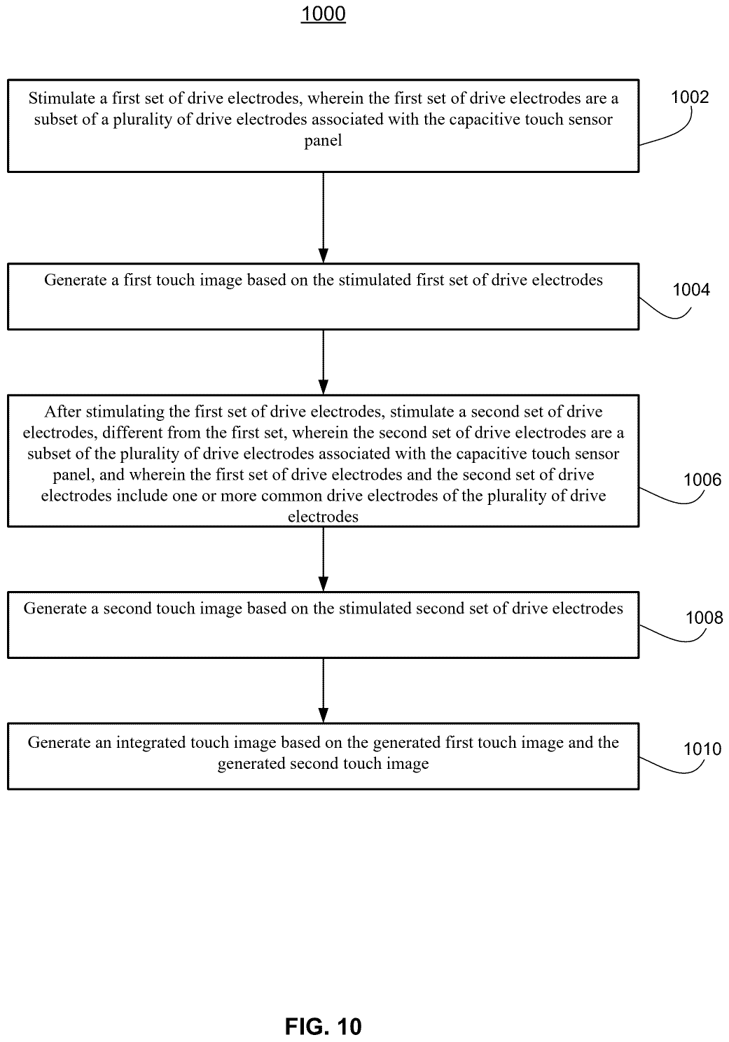

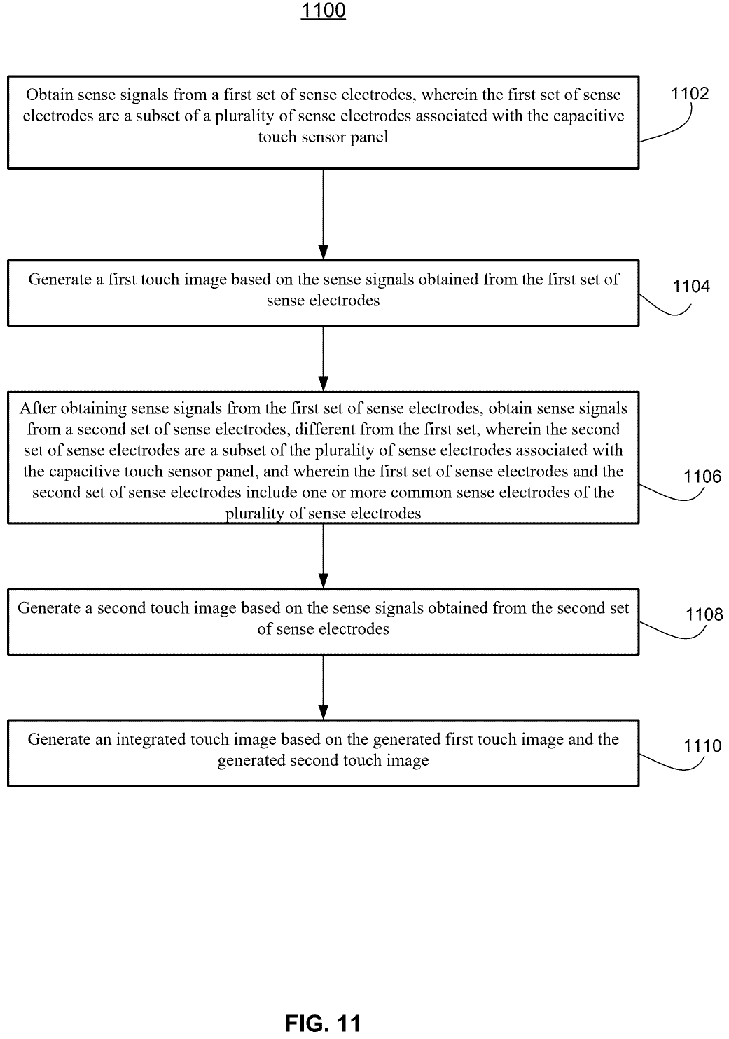

FIG. 9 illustrates an exemplary multi-step touch detection process according to one or more examples of the disclosure. The example 900 of FIG. 9 is similar to the example 600 of FIG. 6, except that the drive electrodes 910 are driven in two separate groups 902a-902e and 914a-914c. In the example 900 of FIG. 9, a first group of drive electrodes 902a-902e are scanned in a first step 1, while a second set 914a-914e (which included some drive electrodes that were part of the first group) are driven at a second step (described in further detail below). In one or more examples, the first group and the second group collectively include each and every drive electrode of the touch sensor panel such that at the conclusion of the second step of the multi-step scanning process, all of the drive electrodes of the touch sensor panel have been driven with a drive signal.

In one or more examples, the first step of the multi-step scanning process (referred to in FIG. 9 as Step 1) includes scanning a first group of drive electrodes 910. In one or more examples, the first group of sense electrodes includes a plurality of sub-groups of sense electrodes 902a-902f. Optionally, each sub-group of drive electrodes 902a-902f includes one or more adjacent sets of sense electrodes (e.g., drive electrodes that are next to one another and/or have no non-driven drive electrodes intervening between them). In some examples, each sub-group of drive electrodes 902a-902f are separated from one another by one or more groups of non-driven drive electrodes 904a-904e. In one or more examples, the non-driven drive electrodes 904a-904c of Step 1 represent the drive electrodes 910 that are not driven during Step 1. In one or more examples, at step 1, a touch ASIC receives a partial touch image that includes any touch inputs applied to the portions of the touch sensor panel that coincide with the intersections of the drive electrodes 610 belonging to sub-groups 902a-902f with the sense electrodes.

In one or more examples, upon completion of Step 1, the process of example 900 moves to Step 2 wherein a second touch image is generated by scanning all of the sense electrodes 912 of touch sensor panel 908, and driving a second sub-group 914a-914g of drive electrodes 910. In some examples, the second sub-group 914a-914g of drive electrodes includes the drive electrodes that were not previously scanned as part of Step 1. Optionally, and as illustrated in the example 900 of FIG. 9, the second sub-group 914a-914g include one or more drive electrodes 910 that were also previously scanned as part of Step 1 of the multi-step scanning process. In some examples, each sub-group of drive electrodes 914a-914g are separated from one another by one or more groups of non-driven drive electrodes 916a-916f. In one or more examples, the non-driven drive electrodes 916a-916f of Step 2 represent the drive electrodes 910 that are not driven during Step 2. In one or more examples, at Step 2, the touch ASIC receives a partial touch image that includes any touch inputs applied to the portions of the touch sensor panel that coincide with the intersections of the drive electrodes 910 of sub groups 914a-914g, with the sense electrodes (e.g., the drive electrodes 910 of touch sensor panel 908 that are scanned as part of Step 2).

In one or more examples, the first sub-group 902a-902f of drive electrodes driven as part of Step 1, and the second sub-group 914a-914g driven as part of Step 2 to form distinct patterns across the touch sensor panel. For instance, as illustrated in example 900 of FIG. 9, at the top edge of the touch sensor panel, in Step 1, the first four drive electrodes (e.g., sub-group 902a) are driven as part of Step 1. In some examples, sub-group 902a is separated from sub-group 902b by the first sub-group of non-driven electrodes 904a. As illustrated in the example of Step 1, the first four drive electrodes of touch sensor panel 908 are driven, then the next two drive electrodes are non-driven, and the pattern repeats for the entirety of the touch sensor panel 908 (from top to bottom).

In one or more examples, the pattern of drive electrode sub-groups is different in Step 2 with respect to Step 1. For instance, as shown in Step 2, the pattern begins (from the top of touch sensor panel 908) with a first group of non-driven drive electrodes 916a, followed by the first sub-group 914a of drive electrodes that are driven as part of step 2. This pattern optionally repeats (e.g., 2 non-driven, followed by four driven drive electrodes) from top to bottom for the entirety of the touch sensor panel 908. In some examples, the starting drive electrode of the second sub-group of sense electrodes is displaced from the left edge of the touch sensor by the number of non-scanned sense electrodes that separate the first sub-group 902a and the second sub-group 902b of the first set of sense electrodes. For instance, as illustrated in the example of FIG. 9, the first sub-group 902a includes four drive electrodes 910, the second sub-group 902b includes four drive electrodes 910, and sub-groups 902a and 902b are separated by two non-driven drive electrodes 904a. In some examples, because there are two non-driven sense electrodes between sub-groups of driven drive electrodes, the second set of drive electrodes (e.g., the drive electrodes driven during the second step of the multi-step scanning process) will not begin until the third drive electrode from the top edge of the touch sensor panel 908, with the first two drive electrodes (e.g., sub-group 916a of the touch sensor panel (e.g., from the top edge) being non-driven as part of the second step of the multi-step scanning process.

In some examples, the method 1000 is performed at an electronic device (described above). In one or more examples, the electronic device stimulates (1002) a first set of drive electrodes, wherein the first set of drive electrodes are a subset of a plurality of drive electrodes associated with the capacitive touch sensor panel. In one or more examples, the capacitive touch sensor panel includes a hardware architecture described above with respect to FIGS. 1-5 above. For instance, in one or more examples, the touch sensor panel includes drive electrodes that are stimulated by an electrical signal provided by the touch sensor panel using an application-specific integrated circuit (ASIC) or other similar component. In one or more examples, the drive electrodes are capacitively coupled to one or more sense electrodes. Thus, in some examples, when the drive electrodes are stimulated with the electrical signal, a portion of the electrical signal is capacitively coupled to the sense electrodes. In some examples, a finger of a user or other input element when touching the touch sensor panel can also capacitively couple the electrical signal causing a change in the amount of electrical signal that is capacitively coupled to the sense electrodes. This change is detected by the touch sensor panel to determine a location as to where the touch or input (e.g., from a stylus or other input device) is occurring on the touch sensor panel as described above with respect to the discussion of FIGS. 1-5. In some examples, rather than stimulating all of the drive electrodes of the touch sensor panel, a first set of drive electrodes (e.g., a portion of the drive electrodes but not all) are stimulated in a first step of a process to generating a complete touch image (e.g., an image that is meant to determine where on the touch sensor panel a touch input is occurring as described above).

In some examples, the electronic device generates (1004) a first touch image based on the stimulated first set of drive electrodes. In some examples, the first touch image represents a partial touch image of the panel such as there is no touch image at the portions of the touch sensor panel corresponding to non-stimulated drive electrodes that are not part of the first set of drive electrodes. Thus, in one or more examples, and as described in further detail below, the first touch image represents a first step in a multi-step process for acquiring a complete touch image of the touch sensor panel.

In some examples, after stimulating the first set of drive electrodes, the electronic device stimulates (1006) a second set of drive electrodes, different from the first set, wherein the second set of drive electrodes are a subset of the plurality of drive electrodes associated with the capacitive touch sensor panel, and wherein the first set of drive electrodes and the second set of drive electrodes include one or more common drive electrodes of the plurality of drive electrodes.

In some examples, the electronic device generates (1008) a second touch image based on the stimulated second set of drive electrodes. In some examples, the second set of drive electrodes, includes one or more drive electrodes that are also part of the first set of drive electrodes, but also includes one or more drive electrodes of the touch sensor panel that are not part of the first set of drive electrodes. In one or more examples, each drive electrode that is part of the touch sensor panel is either included in the first set of the drive electrodes, the second set of drive electrodes, or both. In some examples, the second touch image represents a partial touch image of the panel such as there is no touch image at the portions of the touch sensor panel corresponding to non-stimulated drive electrodes that are not part of the second set of drive electrodes. Thus, in one or more examples, and as described in further detail below, the second touch image represents a second step in a multi-step process for acquiring a complete touch image of the touch sensor panel. Since between the first set of drive electrodes and the second set of drive electrodes, each and every drive electrode of the touch sensor panel is stimulated, the first touch image and the second touch image can be combined (described in further detail below) to generate a complete touch image of the entire touch sensor panel.

In some examples, the electronic device generates (1010) an integrated touch image based on the generated first touch image and the generated second touch image. In some examples, the first touch image and the second touch image are used to generate an integrated touch image that represents a complete scan of the touch sensor panel. The example described above includes a two-step process for generating an integrated touch image, but the example should not be seen as limiting. In one or more examples, the multi-step scan process for generating an integrated touch image can include more than two steps, wherein each step corresponds to a specific set of drive electrodes (but not all of the drive electrodes) that are part of the touch sensor panel.

In some examples, generating an integrated touch image based on the generated first touch image and the generated second touch image includes concatenating the first touch image and the second touch image. In one or more examples, concatenating the first touch image and the second touch image to generate the integrated touch image refers to inputting the first touch image and the second touch image as two separate channels (e.g., two separate inputs) into an integration module that is configured to generate an integrated touch image. In some examples, the integration module is configured to take in one or more touch images at its input and generate an integrated touch image that reflects the locations of touch inputs on the touch sensor panel to be used by the electronic device to interpret touch inputs.

In some examples, generating the integrated touch image based on the generated first touch image and the generated second touch image includes combining the first touch image and the second touch image. In some examples, combining the first touch image and the second touch refers to generating a single touch image that is then provided to the integrator module for processing to generate the touch image that is ultimately used by the electronic device to determine the location of touches on the touch sensor panel.

In some examples, combining the first touch image and the second touch image includes determining an average touch image associated with the common drive electrodes of the first set of drive electrodes and the second set of drive electrodes. In one or more examples, combining can refer to determining an average of the first touch image and the second touch image. For instance, the recorded sense signals for each sense electrode of each touch image are added together and divided by the number of touch images (or overlapping portions of the touch images) to arrive at an average value for each sense electrode. Thus, in the example of a two-step multi-scan process, the first touch image and the second touch image are added together (e.g., each sense line pertaining to the first touch image is summed with its counterpart from the second touch image) and the sum is divided by two to arrive at a combined touch image.

In some examples, generating the integrated touch image based on the generated first touch image and the second touch image includes applying a machine learning model to the generated first touch image and the second touch image. In some examples, the machine learning model (e.g., a neural network that includes one or more layers implemented in either hardware, software, or both) generates an integrated touch image (e.g., acts an integration module as described above). In some examples, and as described in further detail below, the machine learning model includes any type of machine learning classifier including but not limited a supervised learning model, a semi-supervised learning model, and an unsupervised learning model. In some examples, the machine learning model is used to not only produce an integrated touch image from the first and second touch images, but also to discriminate (e.g., classify) touch signals in the first and second image from noise signals. In one or more examples, the output of the machine learning model (e.g., the integrated touch image) includes an indication of the location on the touch sensor panel where a touch input has been detected with any noise signals (signals caused by internal or external noise to the electronic device) either removed completely or substantially reduced to thereby produce a high-fidelity (e.g., the probability of a false touch reduced to below a threshold amount) touch image that can be used by the electronic device for the purpose of determining the location of a touch signal.

In some examples, applying the machine learning classifier to the generated first touch image and the second touch image, includes concatenating the first touch image and the second touch image, and applying the machine learning classifier to the concatenated first touch image and second touch image. In some examples, and as described with respect to FIG. 7, the first touch image and the second touch image (e.g., the product of the first operation/step and second operation/step, respectively) are concatenated either prior to being input into the machine learning model, or by the machine learning model itself. In some examples, concatenating the first touch image and the second touch image includes inputting the first touch image and the second touch image as a single larger image (e.g., the first touch image and the second touch image are serially combined) to form a large touch image that the machine learning model is trained to operate on (e.g., the machine learning model is trained to input a concatenated touch image and output an integrated touch image).

In some examples, applying the machine learning classifier to the generated first touch image and the second touch image, includes combining the first touch image and the second touch image, and applying the machine learning classifier to the combined first touch image and second touch image. In some examples, and as described with respect to FIG. 8, the first touch image and the second touch image (e.g., the product of the first step and second step respectively) are combined either prior to being input into the machine learning model, or by the machine learning model itself. In some examples, combining the first touch image and the second touch image includes inputting the first touch image and the second touch image as a single image (e.g., the first touch image and the second touch image are combined to form a single touch image that is then inputted into the machine learning model) to form a single touch image that the machine learning model is trained to operate on (e.g., the machine learning model is trained to input a combined touch image and output an integrated touch image). In some examples, combining the first touch image with the second touch image includes generating a single touch image based on the first touch image and the second touch image to create an integrated touch image that is then inputted into a machine learning model. In the example of combining, the input to the machine learning model is a single touch image that is generated out of the first touch image and the second touch image. In contrast, in the example of concatenation, the first touch image and the second touch image are separate inputs into the machine learning model that acts on the individual image to create an integrated output touch image (as described above).

In some examples, combining the first touch image and the second touch image includes determining an average touch image associated with the common drive electrodes of the first set of drive electrodes and the second set of drive electrodes. In some examples, the common drive electrodes (e.g., the drive electrodes that are both in the first set of drive electrodes and the second set of drive electrodes) are averaged as part of the process to combine the first touch image and the second touch image. In some examples, the non-common drive electrodes are added to the integrator without averaging since there is only one scan of the non-common drive electrode in the multi-step scanning process. In one or more examples, the first touch image and the second touch image can be equally weighted when averaging is performed. Alternatively, in some example, the first touch image and the second touch image can be weighted (e.g., one touch image is weighted higher than the other) when averaging.

In some examples, the machine learning model is trained using a supervised learning process. In some examples, the machine learning is generated (e.g., trained) using a supervised learning process that utilized labeled datasets to train algorithms that can produce integrated touch images from the multi-step scanning process described above. In some examples, the labeled datasets (e.g., annotated datasets) include exemplary input touch images (either combined or concatenated touch images that are input into the machine learning model as part of the multi-step scanning process). In some examples, the annotated training samples includes labels/annotations that identify true (and known) touch signals in addition to identifying signals that could yield false positives, including but not limited to foreign body object contacts (e.g., fluid such as water that is present on a touch sensor panel) and/or other non-touch phenomenon that could induce a false positive result.

In some examples, the supervised learning process includes training the machine learning model with one or more training touch images that include known touch signals and known noise signals. In one or more examples, the labeled datasets that are utilized as part of the supervised learning process includes labels associated with training samples that identify signals that are associated with noise that is generated from external sources and/or generated from sources internal to the electronic device. In some examples, the signals that are associated with legitimate touches or inputs (e.g., known touch signals) to the touch sensor panel are also identified (e.g., labeled) thus providing the machine learning model with example inputs that can help the machine learning discriminate between touch signals and noise signals that could potentially affect the fidelity of an integrated touch signal that is generated as part of the multi-step scanning process.

In some examples, generating the first touch image includes detecting a sense signal at a one or more sense electrodes of the capacitive touch sensor panel when the first set of drive electrodes are stimulated. In one or more examples, the drive electrodes are capacitively coupled to one or more sense electrodes. Thus, in some examples, when the drive electrodes are stimulated with the electrical signal, a portion of the electrical signal is capacitively coupled to the sense electrodes. In some examples, a finger of a user or other input element when touching the touch sensor panel can also capacitively couple the electrical signal causing a change in the amount of electrical signal that is capacitively coupled to the sense electrodes. This change is detected by the touch sensor panel to determine a location as to where the touch or input is occurring on the touch sensor panel as described above with respect to the discussion of FIGS. 1-5. In some examples, rather than stimulating all of the drive electrodes of the touch sensor panel, a first set of drive electrodes (e.g., a portion of the drive electrodes but not all) are stimulated in a first step of a process to generating a complete touch image (e.g., an image that is meant to determine where on the touch sensor panel a touch input is occurring as described above).

In some examples, generating the second touch image includes detecting a sense signal at the one or more sense electrodes of the capacitive touch sensor panel when the second set of drive electrodes are stimulated. In one or more examples, the second touch image is generated by detecting a signal the one or more sense electrodes of the capacitive touch sensor panel, similar to the examples described above.

In some examples, the first set of drive electrodes includes a first sub-group of drive electrodes and a second sub-group of drive electrodes, and wherein the first sub-group and the second sub-group of adjacent drive electrodes are separated by one or more non-stimulated drive electrodes. In one or more examples, the first set of drive electrodes include a set of drive electrodes that form a pattern with respect to the touch sensor panel in terms of the position of the drive electrodes on the touch sensor panel. For instance, and as described above with respect to FIG. 6, the first set of drive electrodes includes a pattern that includes four adjacent drive electrodes followed by two non-stimulated drive electrodes, wherein the pattern repeats over the entirety of the touch sensor panel. In one or more examples, two adjacent drive electrodes refers to a pair of adjacent drive electrodes that do not have any intervening drive electrodes between them. In some embodiments, the set of drive electrodes belonging to the first set of drive electrodes may not be adjacent, but can still form a pattern across the touch sensor panel. In some examples, the number of “adjacent” drive electrodes within the first set of drive electrodes is variable and can be dependent on factors such as the size of the touch sensor panel, the number of drive signals that can be generated by the touch controller (described above with respect to FIGS. 4-5), as well as the drive electrodes that are part of the second set of drive electrodes. In some embodiments, the location of one or more the drive electrodes within the first set of drive electrodes are the same as one or more drive electrodes within the second set of drive electrodes. However, in one or more examples, all of the drive electrodes of the touch sensor panel are included in either the first set of drive electrodes, the second set of drive electrodes or both. Thus, in some examples, none of the drive electrodes of the touch sensor panel are non-stimulated in both the first set of drive electrodes and the second set of drive electrodes.

In some examples, a starting drive electrode associated with the second set of drive electrodes is based on a number of non-stimulated drive electrodes separating the first sub-group and the second sub-group of adjacent drive electrodes of the first set of drive electrodes. In one or more examples, “starting drive electrode” refers to the first drive electrode that is part of a set of drive electrodes (e.g., first or second) starting from a particular edge of the touch sensor panel. For instance, starting from the left edge of the touch sensor panel, the starting drive electrode of the first set of drive electrodes would be the first drive electrode that is stimulated as part of the first step of the multi-scan process that is closest to the left edge of the touch sensor panel. Similarly, for the second set of drive electrodes, starting from the left edge of the touch sensor panel, the starting drive electrode of the second set of drive electrodes would be the first drive electrode that is stimulated as part of the second step of the multi-scan process that is closest to the left edge of the touch sensor panel. In one or more examples, the starting drive electrode of the first set of drive electrodes is the first drive electrode starting from the left edge of the touch sensor panel and is part of the first sub-group of drive electrodes of the first set of drive electrodes. In some examples, the starting drive electrode of the second is displaced from the left edge of the touch sensor by the number of non-stimulated drive electrodes that separate the first sub-group and the second sub-group of the first set of drive electrodes. For instance, if there are three drive electrodes separating the first sub-group and the second-subgroup, then the second set of drive electrodes (e.g., the drive electrodes stimulated during the second step of the multi-step scanning process) will not begin until the fourth drive electrode from the left edge of the touch sensor panel, with the first three-drive electrodes of the touch sensor panel (e.g. from the left edge) being non-stimulated as part of the second step of the multi-step scanning process.

In some examples, the method 1100 is performed at an electronic device (described above). In one or more examples, the electronic device obtains (1102) sense signals from a first set of sense electrodes, wherein the first set of sense electrodes are a subset of a plurality of sense electrodes associated with the capacitive touch sensor panel; In one or more examples, the capacitive touch sensor panel includes a hardware architecture described above with respect to FIGS. 1-5 above. For instance, in one or more examples, the touch sensor panel includes drive electrodes that are stimulated by an electrical signal provided by the touch sensor panel using an application-specific integrated circuit (ASIC) or other similar component. In one or more examples, the drive electrodes are capacitively coupled to one or more sense electrodes. Thus, in some examples, when the drive electrodes are stimulated with the electrical signal, a portion of the electrical signal is capacitively coupled to the sense electrodes. In some examples, a finger of a user or other input element when touching the touch sensor panel can also capacitively couple the electrical signal causing a change in the amount of electrical signal that is capacitively coupled to the sense electrodes. This change is detected by the touch sensor panel to determine a location as to where the touch or input (e.g., from a stylus or other input device) is occurring on the touch sensor panel as described above with respect to the discussion of FIGS. 1-5. In some examples, rather than obtaining sense signals from all of the sense electrodes of the touch sensor panel simultaneously, sense signals are obtained from a first set of sense electrodes (e.g., a portion of the sense electrodes but not all) in a first step of a process to generating a complete touch image (e.g., an image that is meant to determine where on the touch sensor panel a touch input is occurring as described above).

In one or more examples, the electronic device generates (1104) a first touch image based on the sense signals obtained from the first set of sense electrodes. In some examples, the first touch image represents a partial touch image of the panel such as there is no touch image at the portions of the touch sensor panel corresponding to non-scanned sense electrodes (e.g that are not part of the first set of sense electrodes). Thus, in one or more examples, and as described in further detail below, the first touch image represents a first step in a multi-step process for acquiring a complete touch image of the touch sensor panel.

In one or more examples, the electronic device after obtaining sense signals from the first set of sense electrodes, obtains (1106) sense signals from a second set of sense electrodes, different from the first set, wherein the second set of sense electrodes are a subset of the plurality of sense electrodes associated with the capacitive touch sensor panel, and wherein the first set of sense electrodes and the second set of sense electrodes include one or more common sense electrodes of the plurality of sense electrodes.

In one or more examples, the electronic device generates (1108) a second touch image based on the sense signals obtained from the second set of sense electrodes. In some examples, the second set of sense electrodes, includes one or more sense electrodes that are also part of the first set of sense electrodes, but also includes one or more sense electrodes of the touch sensor panel that are not part of the first set of sense electrodes. In one or more examples, each sense electrode that is part of the touch sensor panel is either included in the first set of the sense electrodes, the second set of sense electrodes, or both. In some examples, the second touch image represents a partial touch image of the panel such as there is no touch image at the portions of the touch sensor panel corresponding to non-scanned sense electrodes that are not part of the second set of sense electrodes. Thus, in one or more examples, and as described in further detail below, the second touch image represents a second step in a multi-step process for acquiring a complete touch image of the touch sensor panel. Since between the first set of sense electrodes and the second set of sense electrodes, each and every sense electrode of the touch sensor panel is scanned (e.g., read to determine if a touch signal exists at the sense electrode in response to stimulation of the drive electrodes), the first touch image and the second touch image can be combined (described in further detail below) to generate a complete touch image of the entire touch sensor panel.

In one or more examples, the electronic device generates (1110) an integrated touch image based on the generated first touch image and the generated second touch image. In some examples, the first touch image and the second touch image are used to generate an integrated touch image that represents a complete scan of the touch sensor panel. The example described above includes a two-step process for generating an integrated touch image, but the example should not be seen as limiting. In one or more examples, the multi-step scan process for generating an integrated touch image can include more than two steps, wherein each step corresponds to a specific set of sense electrodes (but not all of the sense electrodes) that are part of the touch sensor panel.

In one or more examples, generating an integrated touch image based on the generated first touch image and the generated second touch image includes concatenating the first touch image and the second touch image. In one or more examples, concatenating the first touch image and the second touch image to generate the integrated touch image refers to inputting the first touch image and the second touch image as two separate channels (e.g., two separate inputs) into an integration module that is configured to generate an integrated touch image. In some examples, the integration module is configured to take in one or more touch images at its input and generate an integrated touch image that reflects the locations of touch inputs on the touch sensor panel to be used by the electronic device to interpret touch inputs.

In one or more examples, generating the integrated touch image based on the generated first touch image and the generated second touch image includes combining the first touch image and the second touch image. In some examples, combining the first touch image and the second touch refers to generating a single touch image that is then provided to the integrator module for processing to generate the touch image that is ultimately used by the electronic device to determine the location of touches on the touch sensor panel.

In one or more examples, combining the first touch image and the second touch image includes determining an average touch image associated with the common sense electrodes of the first set of sense electrodes and the second set of sense electrodes. In one or more examples, combining can refer to determining an average of the first touch image and the second touch image. For instance, the recorded sense signals for each sense electrode of each touch image are added together and divided by the number of touch images (or overlapping portions of the touch images) to arrive at an average value for each sense electrode. Thus, in the example of a two-step multi-scan process, the first touch image and the second touch image are added together (e.g., each sense electrode pertaining to the first touch image is summed with its counterpart from the second touch image) and the sum is divided by two to arrive at a combined touch image.

In one or more examples, generating the integrated touch image based on the generated first touch image and the second touch image includes applying a machine learning model to the generated first touch image and the second touch image. In some examples, the machine learning model (e.g., a neural network that includes one or more layers implemented in either hardware, software, or both) generates an integrated touch image (e.g., acts an integration module as described above). In some examples, and as described in further detail below, the machine learning model includes any type of machine learning classifier including but not limited a supervised learning model, a semi-supervised learning model, and an unsupervised learning model. In some examples, the machine learning model is used to not only produce an integrated touch image from the first and second touch images, but also to discriminate (e.g., classify) touch signals in the first and second image from noise signals. In one or more examples, the output of the machine learning model (e.g., the integrated touch image) includes an indication of the location on the touch sensor panel where a touch input has been detected with any noise signals (signals caused by internal or external noise to the electronic device) either removed completely or substantially reduced to thereby produce a high-fidelity (e.g., the probability of a false touch reduced to below a threshold amount) touch image that can be used by the electronic device for the purpose of determining the location of a touch image.

In one or more examples, applying the machine learning classifier to the generated first touch image and the second touch image, includes concatenating the first touch image and the second touch image, and applying the machine learning classifier to the concatenated first touch image and second touch image. In some examples, and as described with respect to FIG. 7, the first touch image and the second touch image (e.g., the product of the first operation/step and second operation/step, respectively) are concatenated either prior to being input into the machine learning model, or by the machine learning model itself. In some examples, concatenating the first touch image and the second touch image includes inputting the first touch image and the second touch image as a single larger image (e.g., the first touch image and the second touch image are serially combined) to form a large touch image that the machine learning model is trained to operate on (e.g., the machine learning model is trained to input a concatenated touch image and output an integrated touch image).

In one or more examples, applying the machine learning classifier to the generated first touch image and the second touch image, includes combining the first touch image and the second touch image, and applying the machine learning classifier to the combined first touch image and second touch image. In some examples, and as described with respect to FIG. 8, the first touch image and the second touch image (e.g., the product of the first step and second step respectively) are combined either prior to being input into the machine learning model, or by the machine learning model itself. In some examples, combining the first touch image and the second touch image includes inputting the first touch image and the second touch image as a single image (e.g., the first touch image and the second touch image are combined to form a single touch image that is then inputted into the machine learning model) to for a single touch image that the machine learning model is trained to operate on (e.g., the machine learning model is trained to input a combined touch image and output an integrated touch image). In some examples, combining the first touch image with the second touch image includes generating a single touch image based on the first touch image and the second touch image to create an integrated touch image that is then inputted into a machine learning model. In the example of combining, the input to the machine learning model is a single touch image that is generated out of the first touch image and the second touch image. In contrast, in the example of concatenation, the first touch image and the second touch image are separate inputs into the machine learning model that acts on the individual image to create an integrated output touch image (as described above).

In one or more examples, combining the first touch image and the second touch image includes determining an average touch image associated with the common sense electrodes of the first set of sense electrodes and the second set of sense electrodes. In some examples, the common sense electrodes (e.g., the sense electrodes that are both in the first set of sense electrodes and the second set of sense electrodes) are averaged as part of the process to combine the first touch image and the second touch image. In some examples, the non-common sense electrodes are added to the integrator without averaging since there is only one scan of the non-common sense electrodes in the multi-step scanning process. In one or more examples, the first touch image and the second touch image can be equally weighted when averaging is performed. Alternatively, in some example, the first touch image and the second touch image can be weighted (e.g., one touch image is weighted higher than the other) when averaging.

In one or more examples, the machine learning model is trained using a supervised learning process. In some examples, the machine learning is generated (e.g., trained) using a supervised learning process that utilized labeled datasets to train algorithms that can produce integrated touch images from the multi-step scanning process described above. In some examples, the labeled datasets (e.g., annotated datasets) include exemplary input touch images (either combined or concatenated touch images that are input into the machine learning model as part of the multi-step scanning process). In some examples, the annotated training samples includes labels/annotations that identify true (and known) touch signals in addition to identifying signals that could yield false positives, including but not limited to foreign body object contacts (e.g., fluid such as water that is present on a touch sensor panel) and/or other non-touch phenomenon that could induce a false positive result.

In one or more examples, the supervised learning process includes training the machine learning model with one or more training touch images that include known touch signals and known noise signals. In one or more examples, the labeled datasets that are utilized as part of the supervised learning process includes labels associated with training samples that identify signals that are associated with noise that is generated from external sources and/or generated from sources internal to the electronic device. In some examples, the signals that are associated with legitimate touches or inputs (e.g., known touch signals) to the touch sensor panel are also identified (e.g., labeled) thus providing the machine learning model with example inputs that can help the machine learning discriminate between touch signals and noise signals that could potentially affect the fidelity of an integrated touch signal that is generated as part of the multi-step scanning process.

In one or more examples, the first set of sense electrodes includes a first sub-group of sense electrodes and a second sub-group of sense electrodes, and wherein the first sub-group and the second sub-group of sense electrodes are separated by one or more non-stimulated drive electrodes. In one or more examples, the first set of sense electrodes include a set of sense electrodes that form a pattern with respect to the touch sensor panel in terms of the position of the sense electrodes on the touch sensor panel. For instance, the first set of sense electrodes includes a pattern that includes four adjacent sense electrodes followed by two non-scanned sense electrodes, wherein the pattern repeats over the entirety of the touch sensor panel. In one or more examples, two adjacent sense electrodes refers to a pair of sense electrodes that do not have any intervening sense electrodes between them. In some embodiments, the set of sense electrodes belonging to the first set of sense electrodes may not be adjacent, but can still form a pattern across the touch sensor panel. In some examples, the number of “adjacent” sense electrodes within the first set of sense electrodes is variable and can be dependent on factors such as the size of the touch sensor panel, the number of drive signals that can be generated by the touch controller (described above with respect to FIGS. 4-5), as well as the sense electrodes that are part of the second set of sense electrodes. In some embodiments, the location of one or more the sense electrodes within the first set of sense electrodes are the same as one or more sense electrodes within the second set of sense electrodes. However, in one or more examples, all of the sense electrodes of the touch sensor panel are included in either the first set of sense electrodes, the second set of sense electrodes or both. Thus, in some examples, none of the sense electrodes of the touch sensor panel are non-scanned in both the first set of sense electrodes and the second set of sense electrodes.

In one or more examples, a starting sense electrode associated with the second set of sense electrodes is based on a number of non-scanned sense electrodes separating the first sub-group and the second sub-group of sense electrodes of the first set of sense electrodes. In one or more examples, “starting sense electrode” refers to the first sense electrode that is part of a set of sense electrodes (e.g., first or second) starting from a particular edge of the touch sensor panel. For instance, starting from the left edge of the touch sensor panel, the starting sense electrode of the first set of sense electrodes would be the first sense electrode that is scanned as part of the first step of the multi-scan process that is closest to the left edge of the touch sensor panel. Similarly, for the second set of sense electrodes, starting from the left edge of the touch sensor panel, the starting sense electrode of the second set of sense electrodes would be the first sense electrode that is scanned as part of the second step of the multi-scan process that is closest to the left edge of the touch sensor panel. In one or more examples, the starting sense electrode of the first set of sense electrodes is the first sense electrode starting from the left edge of the touch sensor panel and is part of the first sub-group of sense electrodes of the first set of sense electrodes. In some examples, the starting sense electrode of the second set of sense electrodes is displaced from the left edge of the touch sensor by the number of non-scanned sense electrodes that separate the first sub-group and the second sub-group of the first set of sense electrodes. For instance, if there are three sense electrodes separating the first sub-group and the second-subgroup, then the second set of sense electrodes (e.g., the sense electrodes scanned during the second step of the multi-step scanning process) will not begin until the fourth sense electrode from the left edge of the touch sensor panel, with the first three sense electrodes of the touch sensor panel (e.g. from the left edge) being non-scanned as part of the second step of the multi-step scanning process.

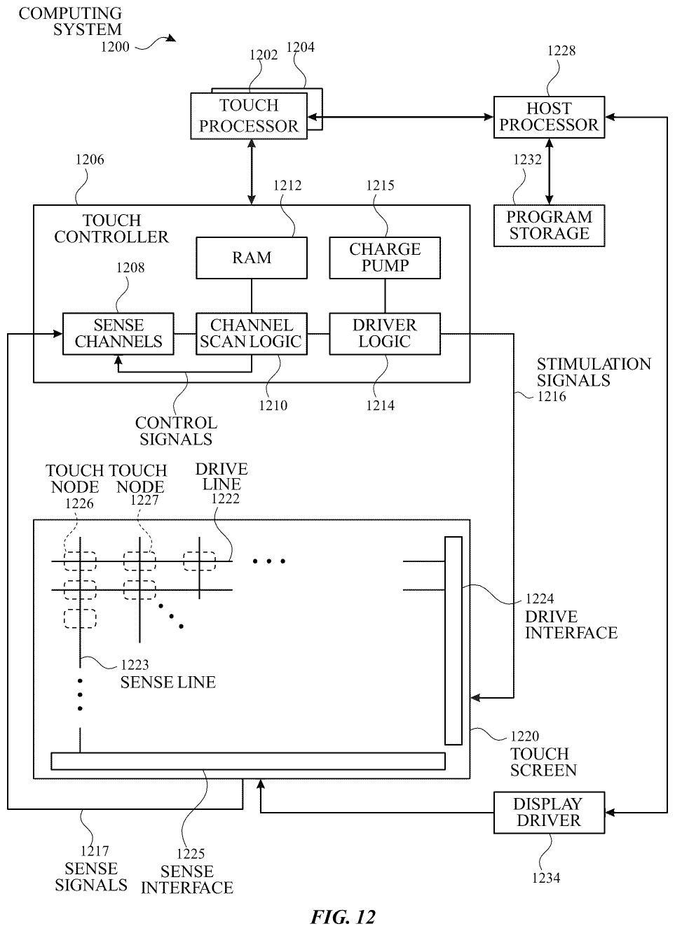

FIG. 12 illustrates an example computing system including a touch screen according to examples of the disclosure, although it should be understood that the illustrated touch screen 1220 (which includes a touch sensor panel) could instead be a touch sensor panel (e.g., without a screen). Computing system 1200 can be included in, for example, a mobile phone, tablet, touchpad, portable or desktop computer, portable media player, wearable device or any mobile or non-mobile computing device that includes a touch screen or touch sensor panel. Computing system 1200 can include a touch sensing system including one or more touch processors 1202, peripherals 1204, a touch controller 1206, and touch sensing circuitry (described in more detail below). Peripherals 1204 can include, but are not limited to, random access memory (RAM) or other types of memory or storage, watchdog timers and the like. Touch controller 1206 (e.g., corresponding to driving circuitry 104 and sensing circuitry 103) can include, but is not limited to, one or more sense channels 1208, channel scan logic 1210 and driver logic 1214. Channel scan logic 1210 can access RAM 1212, autonomously read data from the sense channels and provide control for the sense channels. In addition, channel scan logic 1210 can control driver logic 1214 to generate stimulation signals 1216 at various frequencies and/or phases that can be selectively applied to drive regions of the touch sensing circuitry of touch screen 1220, as described herein. In some instances, touch controller 1206, touch processor 1202 and peripherals 1204 can be integrated into a single application specific integrated circuit (ASIC), and in some instances can be integrated with touch screen 1220 itself. The example computing system 1200 of FIG. 12 can be configured to implement and perform any of the scans described herein.

It should be apparent that the architecture shown in FIG. 12 is one example architecture of computing system 1200, and that the system could have more or fewer components than shown, or a different configuration of components. In some instances, computing system 1200 can include an energy storage device (e.g., a battery) to provide a power supply and/or communication circuitry to provide for wired or wireless communication (e.g., cellular, Bluetooth, Wi-Fi, etc.). The various components shown in FIG. 12 can be implemented in hardware, software, firmware or any combination thereof, including one or more signal processing and/or application specific integrated circuits.

Computing system 1200 can include a host processor 1228 for receiving outputs from touch processor 1202 and performing actions based on the outputs. For example, host processor 1228 can be connected to program storage 1232 and a display controller/driver 1234 (e.g., a Liquid-Crystal Display (LCD) driver). It should be understood that although some examples of the disclosure may be described with reference to LCD displays, the scope of the disclosure is not so limited and can extend to other types of displays, such as Light-Emitting Diode (LED) displays, including Organic LED (OLED), Active-Matrix Organic LED (AMOLED) and Passive-Matrix Organic LED (PMOLED) displays. Display driver 1234 can provide voltages on select (e.g., gate) lines to each pixel transistor and can provide data signals along data lines to these same transistors to control the pixel display image.

Host processor 1228 can use display driver 1234 to generate a display image on touch screen 1220, such as a display image of a user interface (UI), and can use touch processor 1202 and touch controller 1206 to detect a touch on or near touch screen 1220, such as a touch input to the displayed UI. The touch input can be used by computer programs stored in program storage 1232 to perform actions that can include, but are not limited to, moving an object such as a cursor or pointer, scrolling or panning, adjusting control settings, opening a file or document, viewing a menu, making a selection, executing instructions, operating a peripheral device connected to the host device, answering a telephone call, placing a telephone call, terminating a telephone call, changing the volume or audio settings, storing information related to telephone communications such as addresses, frequently dialed numbers, received calls, missed calls, logging onto a computer or a computer network, permitting authorized individuals access to restricted areas of the computer or computer network, loading a user profile associated with a user's preferred arrangement of the computer desktop, permitting access to web content, launching a particular program, encrypting or decoding a message, and/or the like. Host processor 1228 can also perform additional functions that may not be related to touch processing.

Note that one or more of the functions described in this disclosure can be performed by firmware stored in memory (e.g., one of the peripherals 1204 in FIG. 12) and executed by touch processor 1202, or stored in program storage 1232 and executed by host processor 1228. The firmware can also be stored and/or transported within any non-transitory computer-readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “non-transitory computer-readable storage medium” can be any medium (excluding signals) that can contain or store the program for use by or in connection with the instruction execution system, apparatus, or device. In some instances, RAM 1212 or program storage 1232 (or both) can be a non-transitory computer readable storage medium. One or both of RAM 1212 and program storage 1232 can have stored therein instructions, which when executed by touch processor 1202 or host processor 1228 or both, can cause the device including computing system 1200 to perform one or more functions and methods of one or more examples of this disclosure. The computer-readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The firmware can also be propagated within any transport medium for use by or in connection with an instruction execution system, apparatus, or device, such as a computer-based system, processor-containing system, or other system that can fetch the instructions from the instruction execution system, apparatus, or device and execute the instructions. In the context of this document, a “transport medium” can be any medium that can communicate, propagate or transport the program for use by or in connection with the instruction execution system, apparatus, or device. The transport medium can include, but is not limited to, an electronic, magnetic, optical, electromagnetic or infrared wired or wireless propagation medium.

Touch screen 1220 can be used to derive touch information at multiple discrete locations of the touch screen, referred to herein as touch nodes. Touch screen 1220 can include touch sensing circuitry that can include a capacitive sensing medium having a plurality of drive lines 1222 and a plurality of sense lines 1223 (e.g., corresponding to drive lines 105a and sense lines 105b). It should be noted that the term “lines” is sometimes used herein to mean simply conductive pathways, as one skilled in the art will readily understand, and is not limited to elements that are strictly linear, but includes pathways that change direction, and includes pathways of different size, shape, materials, etc. Drive lines 1222 can be driven by stimulation signals 1216 from driver logic 1214 through a drive interface 1224, and resulting sense signals 1217 generated in sense lines 1223 can be transmitted through a sense interface 1225 to sense channels 1208 in touch controller 1206. In this way, drive lines and sense lines can be part of the touch sensing circuitry that can interact to form capacitive sensing nodes, which can be thought of as touch picture elements (touch pixels) and referred to herein as touch nodes, such as touch nodes 1226 and 1227. This way of understanding can be particularly useful when touch screen 1220 is viewed as capturing an “image” of touch (“touch image”). In other words, after touch controller 1206 has determined whether a touch has been detected at each touch nodes in the touch screen, the pattern of touch nodes in the touch screen at which a touch occurred can be thought of as an “image” of touch (e.g., a pattern of fingers touching the touch screen). As used herein, an electrical component “coupled to” or “connected to” another electrical component encompasses a direct or indirect connection providing electrical path for communication or operation between the coupled components. Thus, for example, drive lines 1222 may be directly connected to driver logic 1214 or indirectly connected to driver logic 1214 via drive interface 1224 and sense lines 1223 may be directly connected to sense channels 1208 or indirectly connected to sense channels 1208 via sense interface 1225. In either case an electrical path for driving and/or sensing the touch nodes can be provided.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method for operating a capacitive touch sensor panel to detect touch inputs, the method comprising
stimulating a first set of drive electrodes, wherein the first set of drive electrodes are a subset of a plurality of drive electrodes associated with the capacitive touch sensor panel;
generating a first touch image based on the stimulated first set of drive electrodes;
after stimulating the first set of drive electrodes, stimulating a second set of drive electrodes, different from the first set, wherein the second set of drive electrodes are a subset of the plurality of drive electrodes associated with the capacitive touch sensor panel, and wherein the first set of drive electrodes and the second set of drive electrodes include one or more common drive electrodes of the plurality of drive electrodes;
generating a second touch image based on the stimulated second set of drive electrodes; and
generating an integrated touch image based on the generated first touch image and the generated second touch image.

2. The method of claim 1, wherein generating an integrated touch image based on the generated first touch image and the generated second touch image includes concatenating the first touch image and the second touch image.

3. The method of claim 1, wherein generating the integrated touch image based on the generated first touch image and the generated second touch image includes combining the first touch image and the second touch image, and wherein combining the first touch image and the second touch image includes determining an average touch image associated with the common drive electrodes of the first set of drive electrodes and the second set of drive electrodes.

4. The method of claim 1, wherein generating the integrated touch image based on the generated first touch image and the second touch image includes applying a machine learning model to the generated first touch image and the second touch image.

5. The method of claim 4, wherein applying the machine learning classifier to the generated first touch image and the second touch image, includes:
concatenating the first touch image and the second touch image; and
applying the machine learning classifier to the concatenated first touch image and second touch image.

6. The method of claim 4, wherein applying the machine learning classifier to the generated first touch image and the second touch image, includes:
combining the first touch image and the second touch image, wherein combining the first touch image and the second touch image includes determining an average touch image associated with the common electrodes of the first set of drive electrodes and the second set of drive electrodes; and
applying the machine learning classifier to the combined first touch image and second touch image.

7. The method of claim 4, wherein the machine learning model is trained using a supervised learning process, and wherein the supervised learning process includes training the machine learning model with one or more training touch images that include known touch signals and known noise signals.

8. The method of claim 1, wherein generating the first touch image includes detecting a sense signal at a one or more sense electrodes of the capacitive touch sensor panel when the first set of drive electrodes are stimulated, and wherein generating the second touch image includes detecting a sense signal at the one or more sense electrodes of the capacitive touch sensor panel when the second set of drive electrodes are stimulated.

9. The method of claim 1, wherein the first set of drive electrodes includes a first sub-group of drive electrodes and a second sub-group of drive electrodes, and wherein the first sub-group and the second sub-group of adjacent drive electrodes are separated by one or more non-stimulated drive electrodes.

10. An electronic device comprising:
a capacitive touch sensor panel;
one or more processors;
memory; and
one or more programs, wherein the one or more programs are stored in the memory and configured to be executed by the one or more processors, the one or more programs including instructions for:
stimulating a first set of drive electrodes, wherein the first set of drive electrodes are a subset of a plurality of drive electrodes associated with the capacitive touch sensor panel;
generating a first touch image based on the stimulated first set of drive electrodes;
after stimulating the first set of drive electrodes, stimulating a second set of drive electrodes, different from the first set, wherein the second set of drive electrodes are a subset of the plurality of drive electrodes associated with the capacitive touch sensor panel, and wherein the first set of drive electrodes and the second set of drive electrodes include one or more common drive electrodes of the plurality of drive electrodes;
generating a second touch image based on the stimulated second set of drive electrodes; and
generating an integrated touch image based on the generated first touch image and the generated second touch image.

11. The electronic device of claim 10, wherein generating an integrated touch image based on the generated first touch image and the generated second touch image includes concatenating the first touch image and the second touch image.

12. The electronic device of claim 10, wherein generating the integrated touch image based on the generated first touch image and the generated second touch image includes combining the first touch image and the second touch image, and wherein combining the first touch image and the second touch image includes determining an average touch image associated with the common drive electrodes of the first set of drive electrodes and the second set of drive electrodes.

13. The electronic device of claim 10, wherein generating the integrated touch image based on the generated first touch image and the second touch image includes applying a machine learning model to the generated first touch image and the second touch image.

14. The electronic device of claim 13, wherein applying the machine learning classifier to the generated first touch image and the second touch image, includes:
concatenating the first touch image and the second touch image; and
applying the machine learning classifier to the concatenated first touch image and second touch image.

15. The electronic device of claim 13, wherein applying the machine learning classifier to the generated first touch image and the second touch image, includes:
combining the first touch image and the second touch image, wherein combining the first touch image and the second touch image includes determining an average touch image associated with the common electrodes of the first set of drive electrodes and the second set of drive electrodes; and
applying the machine learning classifier to the combined first touch image and second touch image.

16. The electronic device of claim 13, wherein the machine learning model is trained using a supervised learning process, and wherein the supervised learning process includes training the machine learning model with one or more training touch images that include known touch signals and known noise signals.

17. The electronic device of claim 10, wherein generating the first touch image includes detecting a sense signal at a one or more sense electrodes of the capacitive touch sensor panel when the first set of drive electrodes are stimulated, and wherein generating the second touch image includes detecting a sense signal at the one or more sense electrodes of the capacitive touch sensor panel when the second set of drive electrodes are stimulated.

18. The electronic device of claim 10, wherein the first set of drive electrodes includes a first sub-group of drive electrodes and a second sub-group of drive electrodes, and wherein the first sub-group and the second sub-group of adjacent drive electrodes are separated by one or more non-stimulated drive electrodes.

19. A non-transitory computer readable storage medium storing one or more programs for operating a capacitive touch sensor panel, the one or more programs comprising instructions, which when executed by one or more processors of an electronic device, cause the electronic device to perform a method comprising:
stimulating a first set of drive electrodes, wherein the first set of drive electrodes are a subset of a plurality of drive electrodes associated with the capacitive touch sensor panel;
generating a first touch image based on the stimulated first set of drive electrodes;
after stimulating the first set of drive electrodes, stimulating a second set of drive electrodes, different from the first set, wherein the second set of drive electrodes are a subset of the plurality of drive electrodes associated with the capacitive touch sensor panel, and wherein the first set of drive electrodes and the second set of drive electrodes include one or more common drive electrodes of the plurality of drive electrodes;
generating a second touch image based on the stimulated second set of drive electrodes; and
generating an integrated touch image based on the generated first touch image and the generated second touch image.
